(19) United States
(12) Patent Application Publication
(10) Pub. No.: US 2023/0361264 A1
(43) Pub. Date: Nov. 9, 2023

(54) HYBRID BILAYER ELECTRODE AND METHOD OF MAKING

(71) Applicant: UT-Battelle, LLC, Oak Ridge, TN (US)

(72) Inventors: Jianlin Li, Oak Ridge, TN (US); Dhrupadkumar P. Parikh, Oak Ridge, TN (US)

(21) Appl. No.: 18/140,264

(22) Filed: Apr. 27, 2023

Related U.S. Application Data
(60) Provisional application No. 63/337,693, filed on May 3, 2022.

(51) Int. Cl. H01M 4/04; H01M 4/1391

(52) U.S. Cl. CPC H01M 4/0404; H01M 4/0409; H01M 4/0435; H01M 4/0471; H01M 4/1391; H01M 2004/021

(57) ABSTRACT

A method of manufacturing a hybrid bilayer-coated electrode is provided. The method includes providing a current collector. The method also includes forming a first layer on the current collector, and forming a second layer on top of the first layer by freeze casting a slurry onto the first layer. A hybrid bilayer-coated electrode is also disclosed. The hybrid bilayer-coated electrode includes a current collector. A first layer is formed on a surface of the current collector. A second layer is formed on top of the first layer such that the first layer is sandwiched between the current collector and the second layer. The second layer is formed by freeze casting, and the first layer is formed by other than freeze casting. The second layer has a tortuosity that is less than a tortuosity of the first layer.

### CROSS-REFERENCE TO RELATED APPLICATIONS

This application claims the benefit of U.S. Provisional Application No. 63/337,693, filed May 3, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing a hybrid electrode for batteries such as lithium-ion batteries and other applications.

### BACKGROUND OF THE INVENTION

The growing demand for electrification of the transportation sector has brought about significant development in lithium-ion batteries (LIBs). For example, ongoing research efforts have sought to increase the energy density of LIBs and achieving fast charging. Extreme fast charging (XFC) of lithium-ion batteries is critical for growing the market adoption of electric vehicles. To achieve the widescale adoption of electric vehicles, two major criteria must be met: (1) reduction of the total charging time to be comparable with refueling a gas tank of a combustion engine vehicle; and (2) increase the range of electric vehicles to greater than 300 miles on a single charge. Extensive research has focused on developing high-energy cathodes and next-generation anodes, such as titanium niobium oxide (387 mAh g⁻¹), silicon (3,580 mAh g⁻¹), and lithium-metal (3,862 mAh g⁻¹). However, degradation of silicon particles during cycling and poor cycle life of lithium-metal batteries have limited their application.

Graphite is the most commonly used negative electrode in commercial LIBs because of its low cost and good cycling performance. However, graphite can cause issues during fast charging, including lithium plating and underutilization of active material when the areal loading is increased. The primary reasons for lithium plating are the limitations in charge transfer at the electrode-electrolyte interface and mass transport in the electrolyte phase at the anode. Furthermore, slow lithium-ion kinetics at the interface during the desolvation process, a high activation energy barrier during diffusion through the solid electrolyte interphase layer, and slow ion transport through the electrode structure owing to high-tortuosity pathways lead to lithium plating and dendrite formation in graphite-based chemistries under XFC conditions.

One approach to improve the high-rate capabilities and enhance active material utilization is via tailoring the electrode architecture. Various methods have been deployed to improve the ion transport by changing the electrode architecture. One such method uses sacrificial features to create directional pores in graphite via magnetic alignment, enabling faster charge transport kinetics. Another uses highly ordered laser-patterned electrodes with vertical pores that enable rapid ion transport through graphite electrodes. Yet another utilizes co-extrusion to fabricate dual-scale structures in LiCoO₂. However, a need still exists for a scalable (to mass production levels) method of manufacturing durable battery electrodes that efficiently and effectively allow for extreme fast charging of battery cells.

### SUMMARY OF THE INVENTION

A method of manufacturing a hybrid bilayer-coated electrode is provided. The method includes the step of providing a current collector. The method further includes the step of forming a first layer on the current collector. The method further includes the step of forming a second layer on top of the first layer by freeze casting a slurry onto the first layer.

In specific embodiments, the first layer is formed by coating a slurry-based composition on the current collector and subsequently calendering the slurry-based composition on the current collector.

In particular embodiments, the slurry-based composition includes a solvent component including one or a combination of two or more solvents selected from a group of water, ethanol, propanol, toluene, N-methyl-2-pyrrolidone (NMP), dimethyl sulfoxide (DMSO) and triethyl phosphate (TEP).

In specific embodiments, the slurry used to form the second layer includes one or more solvents, and the second layer is formed by: depositing a coating of the slurry on the first layer; freezing the solvent(s) after depositing the coating; and subsequently subliming the solvent(s) via controlling ambient temperature and/or pressure.

In particular embodiments, the one or more solvents of the slurry for the second layer includes one or a combination of two or more solvents selected from a group of water, ethanol, propanol, toluene, N-methyl-2-pyrrolidone (NMP), dimethyl sulfoxide (DMSO) and triethyl phosphate (TEP).

In specific embodiments, the slurry used to form the second layer is an aqueous slurry.

In specific embodiments, the electrode formed by the method is an anode or a cathode.

In particular embodiments, the anode includes: an active material selected from a group of graphite, graphene, silicon, silicon oxide, germanium, lithium titanium oxide, niobium oxide, and titanium niobium oxide; a binder; and a conductive additive.

In particular embodiments, the cathode includes: an active material selected from a group of lithium compounds including LiMPO₄ wherein M is Fe, Mg, or Mn, LiNiₓMn_{y}Co_{1-x-y}O₂, LiNi_{1.5}Mn_{0.5}O₄, and LiMO₂ wherein M is Ni, Mn, Co, Fe, Al, Ti, or Zn; a binder and a conductive additive.

In specific embodiments, the first layer is densified to have a density equivalent to a range of 15% to 50% porosity.

In specific embodiments, the second layer has a tortuosity that is less than a tortuosity of the first layer.

In particular embodiments, the tortuosity of the second layer is approximately in the range of 1 to 3.

In specific embodiments, the bilayer-coated electrode has an areal loading in the range of 1.5 to 5.5 mAh cm⁻².

In specific embodiments, the step of forming the second layer is performed using a freeze tape caster.

A hybrid bilayer-coated electrode is also disclosed. The hybrid bilayer-coated electrode includes a current collector. A first layer is formed on a surface of the current collector. A second layer is formed on top of the first layer such that the first layer is sandwiched between the current collector and the second layer. The second layer is formed by freeze casting, and the first layer is formed by other than freeze casting. The second layer has a tortuosity that is less than a tortuosity of the first layer.

In specific embodiments, the first layer has a density equivalent to a range of 15% to 50% porosity.

In specific embodiments, the second layer has a tortuosity that is less than a tortuosity of the first layer.

In specific embodiments, the tortuosity of the second layer is approximately in the range of 1 to 3.

In specific embodiments, the bilayer-coated electrode has an areal loading in the range of 1.5 to 5.5 mAh cm⁻².

These and other features of the invention will be more fully understood and appreciated by reference to the description of the embodiments and the drawings.

### BRIEF DESCRIPTION OF THE DRAWING

FIG. 1 is a schematic, cross-sectional view of a hybrid bilayer-coated electrode in accordance with embodiments of the disclosure;

FIGS. 2A and 2B are schematic views of a benchtop freeze tape caster in accordance with embodiments of the method of the disclosure;

FIG. 3 is a graph of the rate performance of conventionally-coated graphite anodes at various porosities using a symmetric cell configuration;

FIG. 4 is a schematic, top view of the hybrid bilayer-coated electrode in accordance with embodiments of the disclosure;

FIG. 5 is another schematic, cross-sectional view of the hybrid bilayer-coated electrode in accordance with embodiments of the disclosure;

FIG. 6 is a schematic, cross-sectional view of a conventionally coated and calendered electrode in accordance with the prior art;

FIG. 7 is a graph of extreme fast charging (XFC) rate performance using a symmetric cell configuration for a hybrid bilayer-coated anode in accordance with embodiments of the disclosure in comparison to a single-layer freeze tape cast anode and a single-layer conventionally-coated anode;

FIG. 8 is a graph of long-term cycling performance using a full-cell configuration for the hybrid bilayer-coated anode in accordance with embodiments of the disclosure in comparison to a single-layer freeze tape cast anode and a single-layer conventionally-coated anode;

FIG. 9 is a graph of capacity retention for the hybrid bilayer-coated anode in accordance with embodiments of the disclosure in comparison to a single-layer freeze tape cast anode and a single-layer conventionally-coated anode;

FIG. 10 is a graph of discharge capacity for the hybrid bilayer-coated anode in accordance with embodiments of the disclosure in comparison to a single-layer freeze tape cast anode and a single-layer conventionally-coated anode for 1,000 cycles;

FIG. 11 is a graph of gravimetric energy during the charging process (lithium insertion) for the hybrid bilayer-coated anode in accordance with embodiments of the disclosure in comparison to a single-layer freeze tape cast anode and a single-layer conventionally-coated anode;

FIG. 12 is a graph of a Nyquist plot and diffusion length for the hybrid bilayer-coated anode in accordance with embodiments of the disclosure in comparison to a single-layer freeze tape cast anode and a single-layer conventionally-coated anode; and

FIGS. 13A and 13B are graphs of the discharge capacity for hybrid bilayer-coated cathodes in accordance with embodiments of the disclosure in comparison to single-layer conventionally-coated cathodes.

### DETAILED DESCRIPTION OF THE CURRENT EMBODIMENTS

As discussed herein, the current embodiments relate to a method of manufacturing a hybrid bilayer-coated electrode, and hybrid bilayer-coated electrodes formed by the method. The method generally includes forming first and second layers on a substrate such as a current collector, the second layer being an outer layer formed on top of the first layer. The second layer is formed by a freeze casting (also known as ice templating or freeze alignment) whereas the first layer is formed by a process that is not freeze casting, i.e. formed by other than freeze casting. The hybrid bilayer-coated electrodes have improved properties including higher charge rate performance under fast charging conditions. Each step of the method is separately discussed below.

The method first includes providing a substrate that is a current collector. The current collector is not particularly limited, and may be any current collector suitable for the use of the electrode such as an anode or cathode of a lithium-ion battery. The current collector may also be selected in view of the other electrode components, such as the binder and active materials thereof. Examples of suitable current collectors generally include materials including aluminum, copper, nickel, titanium, stainless steel, and even some carbonaceous materials. The current collector may be in any form known in the art, such as plates, sheets, foils, etc. Such terms may be overlapping in scope, as the current collector may have any thickness that is suitable for carrying a current, but will typically be selected with a minimal thickness in order to maximize energy density. Other materials and structures, as well as specific treatments (e.g. etching, coating, etc.) may be utilized to enhance the electrochemical stability and electrical conductivity of current collectors; however, it will be appreciated that not all composite current collectors may be suitable for use in the method in all circumstances, as the conditions and materials may be optimized for homogeneous metallic current collectors. Further, the current collector may also be independently selected depending on whether the electrode is a cathode or an anode. In certain embodiments, the electrode may be an anode having a copper current conductor. In specific embodiments, the anode current collector is a copper sheet or foil. In other embodiments, the electrode may be a cathode having an aluminum current collector. In specific embodiments, the cathode current collector is an aluminum sheet or foil.

The method next includes forming a first layer on the current collector. The first layer is formed by conventional coating processes, and particularly by a method/process that is not a freeze casting/ice templating/freeze alignment process. Conventional processes for forming the first layer include, for example, slot-die coating, bar coating, reverse comma coating, doctor blade coating, gravure coating, or other similar process. In some embodiments, the step of forming the first layer includes coating a slurry-based composition on the surface of the current collector. The slurry-based composition includes one or more (i.e., one or a combination of) solvents selected from a group of water, ethanol, propanol, toluene, N-methyl-2-pyrrolidone (NMP), dimethyl sulfoxide (DMSO) and triethyl phosphate (TEP). The slurry-based composition also includes an active material that is described in more detail below. The slurry-based composition may further include a conductive additive (for enhancing the electron conductivity of the active material) and/or a binder that is also described in more detail below. The non-solvent portion of the slurry-based composition may constitute, for example, 80-99 wt. % active material, 0.5-10 wt. % conductive additive, and 0.5-10 wt. % binder. After coating the first layer on the current collector, the first layer is preferably densified by a conventional densification process such as by calendering the coating of slurry-based composition, to reduce the thickness of the first layer and to reduce the density equivalent of the first layer to a range of 15% to 50% porosity. Alternatively, the first layer may be formed on the current collector by a process other than coating and calendering, such as by laminating or cross-linking.

After forming the first layer on the current collector, the method next includes forming a second layer on top of the first layer, such that the first layer is disposed between the current collector and the second layer and is generally (at least nearly completely) sandwiched between the current collector and the second layer. The step of forming the second layer is specifically performed by a freeze casting process, which may also be referred to as an ice templating or freeze alignment process. Particularly, in this step a slurry is freeze cast onto the first layer, which includes depositing a coating of the slurry on the first layer, freezing the solvent portion of the slurry after depositing the coating (temperature required for freezing depends upon the solvent(s) used in the slurry; e.g., for aqueous slurries a temperature less than 0° C. is required) wherein continuous crystals of solvent are formed in the slurry and the solid particles in the slurry are physically pushed by the moving solidification front and concentrated and entrapped between the crystals, and subsequently subliming the solvent portion (from the solid state directly to the gas state) by controlling the ambient temperature and/or pressure of the environment surrounding the second layer. In other words, by controlling the temperature (increased temperature) and/or vacuum level (reduced pressure) around the second layer, the frozen solvent is vaporized to leave a porous structure with unidirectional channels where the frozen solvent crystals were formed. The temperature and/or vacuum pressure necessary for sublimation is dependent upon the solvent(s) used to form the slurry. In some embodiments, the freeze casting process is a freeze tape casting process performed using a freeze tape caster. The slurry composition used to form the second layer includes one or more (i.e., one or a combination of) solvents selected from a group of water, ethanol, propanol, toluene, N-methyl-2-pyrrolidone (NMP), dimethyl sulfoxide (DMSO) and triethyl phosphate (TEP). In some embodiments, the solvent is water such that the slurry is an aqueous slurry. However, other solvents may be used in the alternative or in addition to water, depending on the desired freezing temperature of the solvent portion of the slurry. The slurry also includes an active material that is described in more detail below. The slurry may further include a conductive additive (for enhancing the electron conductivity of the active material) and/or a binder that is also described in more detail below. The non-solvent portion of the slurry may constitute, for example, 80-99 wt. % active material, 0.5-10 wt. % conductive additive, and 0.5-10 wt. % binder.

Subsequent to forming the second layer on the first layer, the resulting bilayer electrode may be sintered.

The active material included in the slurry-based composition used to form the first layer and the slurry used to form the second layer is selected based upon whether the hybrid bilayer-coated electrode formed by the method is to be an anode or a cathode. In the case that the hybrid bilayer-coated electrode is an anode, the active material is selected from a group of graphite, graphene, other various forms of carbon, such as paracrystalline carbon (e.g. carbon black), silicon, silicon oxide, germanium, lithium titanium oxide, niobium oxide, and titanium niobium oxide. On the other hand, in the case that the hybrid bilayer-coated electrode is a cathode, the active material is a lithium compound, particularly a lithium-bearing metal oxide. Examples of such compounds include LiCoO₂, LiMn₂O₄, LiNiO₂, LiCrO₂, LiFePO₄, LiNiO₂, LiMn₂O₄ LiV₂O₅, LiTiS₂, LiMoS₂, LiMnO₂, LiFe_{1-z}M_{y}PO₄, as well as variations of lithium nickel oxides, lithium nickel manganese oxides, lithium nickel manganese cobalt oxides, and the like, exemplified by those having general formulas such as LiNiₓMn_{y}O₂, Li_{1+z}NiₓMn_{y}Co_{1-x-y}O₂, LiNiₓCo_{y}Al_{z}O₂, LiNiₓCo_{y}Mn_{z}O₂, etc., where each x, y, and z is typically a mole fraction of from 0 to 1, where x+y+z=1. In some embodiments, the active material may be selected from a group including LiMPO₄ wherein M is one of Fe, Mg, or Mn, LiNiₓMn_{y}Co_{1-x-y}O₂, LiNi_{1.5}Mn_{0.5}O₄, and LiMO₂ wherein M is one of or a combination of two or more of Ni, Mn, Co, Fe, Al, Ti, or Zn.

The binder included in the slurry-based composition for forming the first layer and the slurry composition for forming the second layer may be an organic binder. The organic binder is typically a polyvinylidene fluoride (PVDF)-based binder (“PVDF binder”). Examples of such PVDF binders generally include, either as a homopolymeric composition, as a copolymer or interpolymer of PVDF and one or more other monomers, or a multi-polymer composition comprising a PVDF homo- or copolymer with one or more other polymers. Examples of particular PVDF binders may include various combinations of polyvinylidene fluorides, polytetrafluoroethylenes, fluorinated ethylene-propylene copolymers (e.g. from tetrafluoroethylene and/or hexafluoropropylene, etc.), and various per- or polyfluoroalkoxy polymers. Alternatively, the binder may be a material that is substantially free from, alternatively are free from PVDF. For example, the binder may include a styrene-butadiene rubber (SBR) binder, a carboxymethyl cellulose (CMC) binder, a poly(acrylic acid) (PAA) binder, or other suitable binder.

The conductive additive included in the slurry-based composition for forming the first layer and the slurry for forming the second layer may be, for example, graphite and/or carbon black.

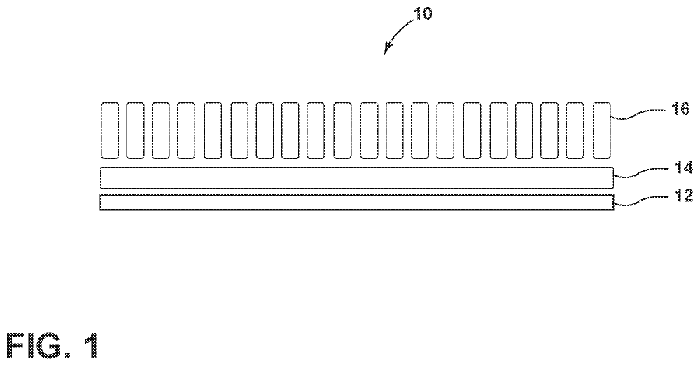

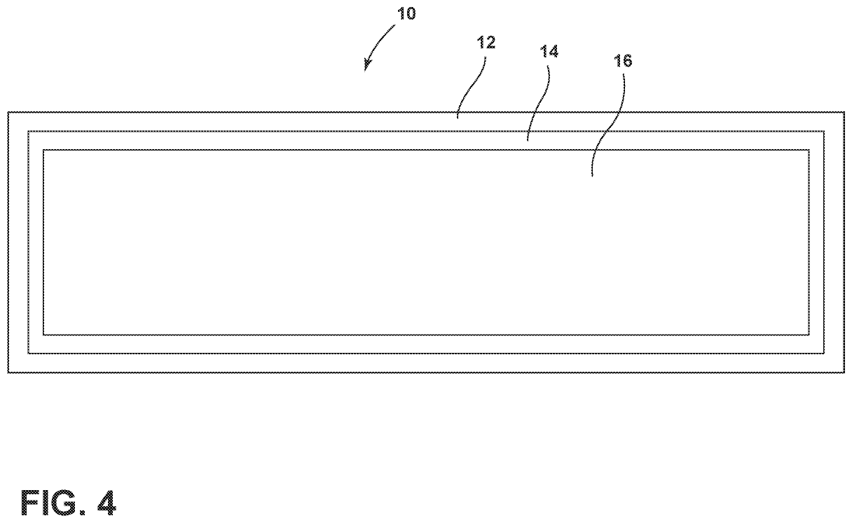

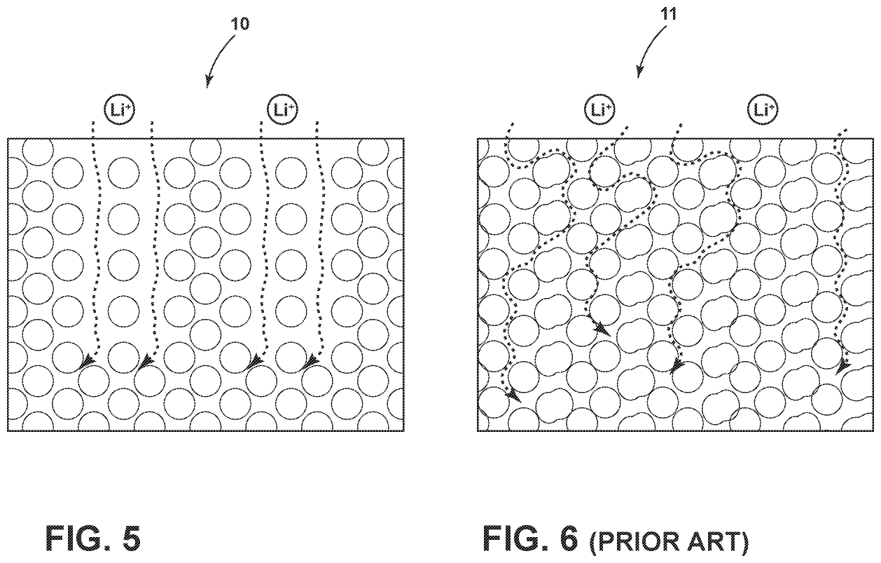

The resulting hybrid bilayer-coated electrode 10 formed by the method has a structure as shown schematically in FIGS. 1 and 4. The current collector 12 is a substrate on which the first layer 14 is formed by a process other than freeze casting, and the second layer 16 is formed by freeze casting on top of the first layer 14 such that the first layer is sandwiched between and directly adjacent to both the current collector 12 and second layer 14. As can be seen schematically in FIG. 1 as well as in FIG. 5, the second layer 16 has a tortuosity that is less than a tortuosity of the first layer 14.

The hybrid bilayer-coated electrode may have an areal loading in the range of 1.5 to 5.5 mAh cm⁻². In the hybrid bilayer-coated electrode, due to the second layer being formed by a freeze casting process and the first layer being formed by a process other than a freeze casting process, the second layer has a tortuosity that is less than a tortuosity of the first layer. In some embodiments, the tortuosity of the second layer may be approximately in the range of 1 to 3, while the tortuosity of the first layer may be approximately in the range of 1.5 to 8. The value of the tortuosity is dependent upon the method used to characterize the tortuosity, as well as the processing conditions used in forming the first and second layers. Further, the thickness of the second layer is typically greater than the thickness of the first layer. For example, the second layer may be at least two times as thick as the first layer, alternatively at least three times as thick, alternatively at least four times as thick, alternatively at least five times as thick, alternatively at least six times as thick, alternatively at least seven times as thick, alternatively at least ten times as thick. As described in more detail in the examples below, the first layer may have a thickness in the range of 30 μm to 50 μm, alternatively in the range of 35 μm to 45 μm, alternatively approximately 40 μm, while the second layer may be in the range of 200 μm to 300 μm. However, it should be understood that the thickness of the second layer may not be greater than the thickness of the first layer, i.e. in some embodiments the first layer may be thicker than second layer.

### EXAMPLES

The present method is further described in connection with the following laboratory examples, which are intended to be non-limiting.

A hybrid bilayer-coated graphite anode was fabricated in accordance with the method disclosed herein (“Example 1”). For comparison, a conventionally coated single layer graphite anode (“Comparative Example 1”) and a single layer freeze tape cast (FTC) graphite anode (“Comparative Example 2”) were also fabricated.

The slurry-based composition used to form the first, conventionally coated layer included as-obtained SLC1520T graphite (Superior Graphite), PVDF (Kureha 9300), and carbon black (C45; Imerys Graphite and Carbon) mixed with NMP as the solvent. The slurry included 92 wt. % graphite, 6 wt. % PVDF, and 2 wt. % C45.

The slurry used to form the second, freeze tape cast layer included SLC150T graphite mixed with styrene butadiene rubber (SBR; 40% solidity, Targray) and sodium carboxymethyl cellulose (average molecular weight of 250,000, degree of substitution equal to 0.7, Sigma Aldrich) as the binder, and C45 as the conductive additive in deionized water as the solvent. The slurry included 90 wt. % graphite, 7 wt. % binder, 1.0 wt. % polyacrylic acid (PAA), and 2 wt. % C45. The PAA additive helped to stabilize the slurry while mixing by reducing the bubble formation in the aqueous slurry that may occur due to the presence of SBR. The binder solution included SBR and carboxymethyl cellulose (CMC) in a mass ratio of approximately 4:1.

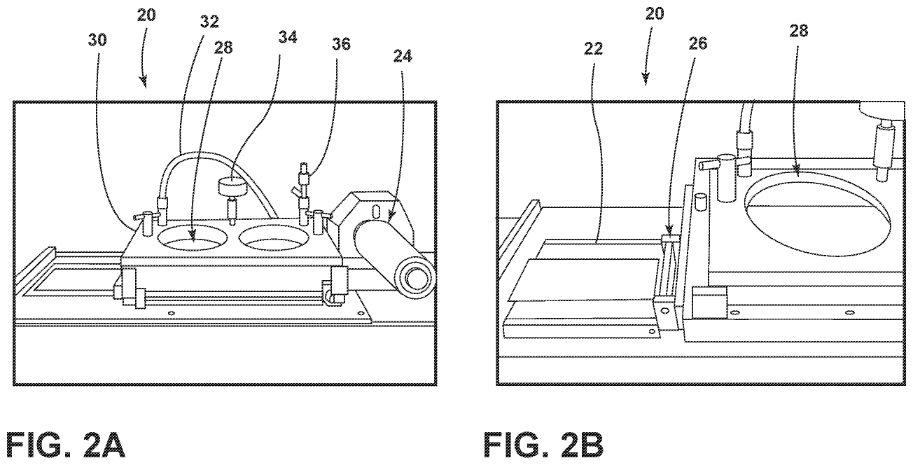

For Example 1, copper foil (15 μm, MTI) was used as the current collector. The first, conventionally-coated layer was coated on the copper foil using a pilot scale roll-to-roll slot-die caster. The as-coated first layer (approximately 50% porosity) was calendered to 35% porosity, followed by vacuum drying at 120° C. overnight. The second, freeze-tape-cast layer was formed on the first layer by freeze tape casting using a benchtop freeze tape caster as shown schematically in FIGS. 2A and 2B. The benchtop freeze tape caster 20 mimicked a scalable roll-to-roll process and included a mylar sheet 22 pulled by a roller 24. A doctor blade 26 was disposed upstream of the freeze bed 28 inside a pressure chamber 30. A vacuum hose 32 was in fluid communication with the pressure chamber 30, and a pressure gauge 34 and pressure release valve 36 were also connected to the chamber. The freezing bed 28 of the freeze tape caster 20 was capable of being lowered to −30° C. to facilitate growth of ice crystals in the slurry. The freezing bed 28 was connected to a vacuum pump via the hose 32, and the pressure gauge 34 was used to monitor the pressure. The copper foil current collector was laid on top of the mylar sheet 22 attached to the roller 24, and the doctor blade 26 was used to cast the slurry on the first layer. A second mylar sheet was used to cover the coating to prevent it from drying. The coated current collector was moved through the freezing bed 28 at a controlled speed to promote the formation of desirable ice crystal structures. Once the ice crystals were formed, the coated current collector was placed under vacuum for 6 to 8 hours to sublimate the ice.

For Comparative Example 1, the same slurry-based composition used to form the first, conventionally coated layer was coated on copper foil current collectors with the pilot-scale roll-to-roll slot-die caster to obtain as-coated graphite electrodes having approximately 50% porosity. Some of the as-coated graphite electrodes were calendered to achieve densities equivalent to 25% and 35% porosity. The graphite electrodes were then dried by vacuum drying at 120° C. overnight.

For Comparative Example 2, the same slurry used to form the second, freeze tape cast layer was applied on copper foil current collectors by freeze tape casting using the freeze tape caster 20.

The coated electrodes had an areal loading of approximately 3 mAh·cm⁻² and were used to assemble coin cells. For full cells, LiNi_{0.6}Mn_{0.2}Co_{0.2}O₂ (NMC622, Targray) cathodes were fabricated using NMP as the solvent and PVDF as the binder. The slurry was uniformly coated on an aluminum foil current collector via a pilot-scale slot-die coater in a dry room environment. The N/P ratio was 1.19 for the full cells. The graphite anodes were assembled into coin cells. The half-cells had lithium metal as the counter electrode. For symmetric cells, two half-cells were assembled, then underwent two formation cycles at 0.1 C, and were charged to 50% state of charge (SOC) before being disassembled inside an argon-filled glove box. The two graphite electrodes from the two disassembled cells were reassembled into symmetric cells. Celgard 2325 separator and 1.2 M LiPF₆ in ethylene carbonate:ethyl methyl carbonate (3:7 by weight) electrolyte were used for both cell configurations. The mass and thickness of all the electrodes were measured by an analytical balance (Mettler) and a micrometer (Mitutoyo).

For extreme fast charging (XFC) rate performance testing, a symmetric cell configuration was used to study the influence of the graphite anode configurations of the examples and comparative examples. The symmetric cells were cycled in the voltage window of −0.5 to 0.5 V. Charging was done using a constant current constant voltage (CCCV) protocol with various constant currents (0.1 C, 5 C, 5.5 C, 6 C, 6.5 C, 7 C, 8 C, and 10 C), followed by constant voltage until the current dropped below C/20 for a total charging time of only 10 min except for the 0.1 C charging. 1 C was defined as 285 mA g⁻¹ of graphite. The discharge process was carried out at C/3. Long-term cycle performance was studied using the full-cell configuration with a NMC622 cathode and the graphite anodes. The full cells were cycled between 3.0 to 4.2 V. The charging was done at a 5 C rate using CCCV protocol with a total charging time of 10 min, and the discharge rate was fixed to C/3. For the full-cell configuration, 1 C was defined as 165 mA g⁻¹ of NMC622.

For diffusion length measurement, symmetric cells with 0% SOC were assembled using the coin-cell configuration under blocking conditions. Electrochemical impedance spectroscopy was used to study the ionic resistance behavior of the different electrodes. Electrochemical impedance was measured over a frequency range of 100 mHz to 1 MHz with an amplitude of 10 mV using a BioLogic cycler (VSP potentiostat). The ionic resistance was calculated by fitting the Nyquist curves using the transmission-line model with a constant phase element (TLM-Q). The ZFit tool in EC-Lab V11.22 was used to perform fitting with an equivalent circuit R2+Ma1, where R2 is the ohmic resistance and Ma1 is the modified restricted diffusion element. The R1 in Ma1 is the ionic resistance (Rᵢₒₙ), which is used to compute the tortuosity (τ) and the diffusion length (L) using the following Equations (1) and (2), respectively.

$$τ = \frac{{R}_{ion} \cdot A \cdot ε \cdot k}{2 d} \qquad ( 1 )$$

$$L = \frac{\sqrt{τ}}{d} \qquad ( 2 )$$

where ε is the electrode porosity, d is the surface area, A is the electrode thickness, and k is the ionic conductivity of the electrolyte. The factor 2 in the denominator of Equation (1) takes into consideration the two electrodes in the symmetric cell configuration.

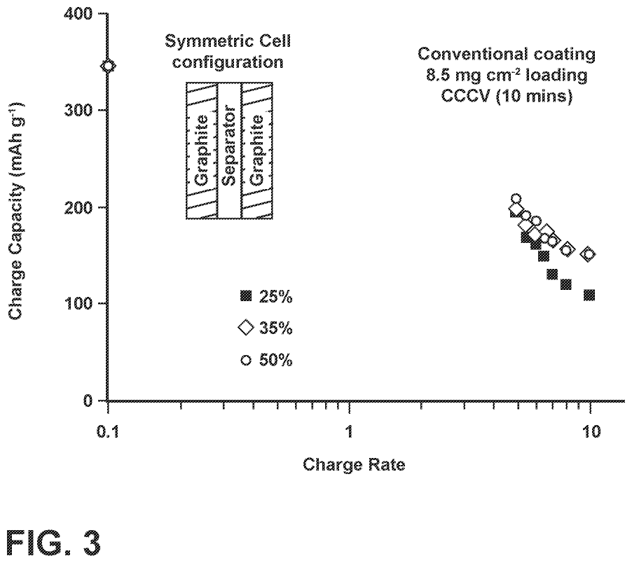

The rate performance of the conventionally coated, single layer graphite anodes (Comparative Example 1) with different porosities in symmetric cells was measured in terms of the specific charge capacity under XFC conditions and shown graphically in FIG. 3. Three porosity conditions (25%, 35%, and 50%) were evaluated, with 8.5 mg cm⁻² mass loading and triplicate cells for each condition. All the cells performed well at a low rate (0.1 C) and had almost identical charge capacities for the different porosity conditions. As the charge rates increased to 5 C and beyond, a decrease in charge capacity was observed owing to mass transport and charge transfer limitations under XFC. Additionally, the charge capacity at XFC conditions reduced with increasing charge rate at the constant current step and increased with increasing porosity. For instance, the charge capacity at 5 C improved from ˜190 mAh g⁻¹ to ˜198 mAh g⁻¹ and ˜205 mAh g⁻¹ when increasing the anode porosity from 25% to 35% and 50%, respectively. When reducing the anode porosity, capacity decrease was more pronounced with increasing charge rate. Notably, the energy density rather than the specific capacity is more important in practical applications. Although the capacity lowered with lowering porosity, the volumetric energy density may be comparable or even higher. Furthermore, reducing porosity also renders less electrolytes, which can benefit the gravimetric energy density and battery cost.

The conventionally coated single-layer graphite anodes (Comparative Example 1) exhibited randomly distributed particles, leading to a more tortuous pathway for lithium-ion diffusion. In contrast, the freeze tape cast (FTC) single layer graphite anodes (Comparative Example 2) had many well aligned channels. The in-plane channel direction was parallel to the coating direction and was almost perpendicular to the copper foil. The channels were created by the formation of ice crystals and subsequent sublimation. The well-aligned channels, which are perpendicular to substrate results in lower tortuosity. The lower electrode tortuosity translates to shorter lithium-ion diffusion length, resulting in improved rate capability at high currents.

The single-layer FTC half-cells of Comparative Example 2 showed excellent cycling at 0.1 C for 5 cycles with an attainable capacity of ˜340 mAh g⁻¹. Similar voltage profiles were observed for the conventionally coated graphite electrodes (Comparative Example 1) at 0.1 C charge and 0.5 C discharge in a half-cell configuration. Overall, the FTC single layer electrodes demonstrated comparable capacity to the conventionally coated electrodes at a low rate. However, the FTC electrodes showed poor mechanical integrity owing to high porosity and even exhibited flaking and delamination from the copper foil while punching circular discs after freezing and drying. Further, the single-layer FTC electrodes tended to delaminate from the copper foil once disassembled from the coin cell to assemble symmetric cells, demonstrating poor structural integrity. This behavior suggests that although there was good cohesion among the solid particles, the adhesion between the solid particles and the copper foil was not sufficient.

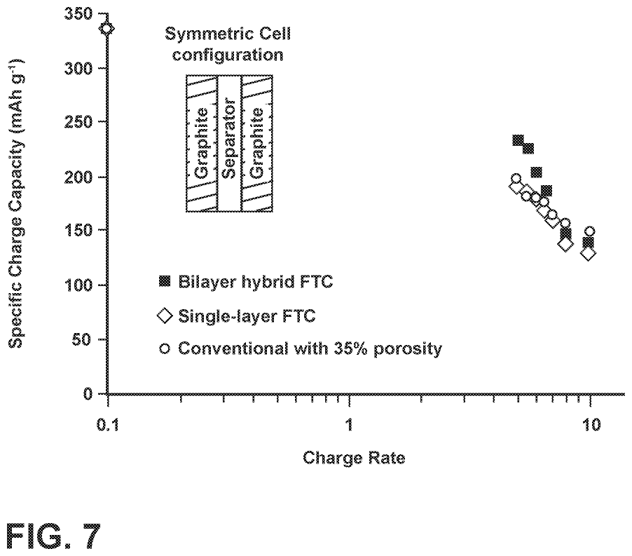

The hybrid bilayer-coated electrode of Example 1 addresses the delamination observed in Comparative Example 2. As discussed above, the hybrid bilayer-coated electrode of Example 1 had a thin, first (bottom) layer formed of a conventionally coated NMP-PVDF-based slurry, and a thicker, second (top) freeze tape cast (FTC) layer formed from an aqueous-based slurry. The thickness of the bottom, first layer was fixed at ˜40 μm, while the thickness of the top, second layer was varied from 200 to 300 μm, and the fabricated bilayer hybrid coatings had areal loadings in the range of 2.8 to 3.0 mAh cm⁻². A schematic of the bilayer hybrid FTC electrode 10 is shown in FIG. 4, with the conventionally coated graphite bottom layer 12 (calendered to 35% porosity) formed on the copper foil current collector 12, and the FTC top layer 16. The calendered bottom layer 14 provided good adhesion to the FTC layer 16 with excellent structural integrity and flexibility. A comparison between a cross-sectional view of the hybrid bilayer-coated electrode 10 and the conventional coated electrode 11 of Comparative Example 1 is shown in FIGS. 5 and 6, respectively. The second, FTC layer provides channeled pathways for lithium-ion diffusion and thus improved the high-rate capabilities of the graphite anode. For sake of comparison, a bottom layer formed from an aqueous-based slurry composition was also investigated. However, cracks and flakes were observed in the electrodes with a bottom layer formed from an aqueous slurry, whereas the electrodes with a bottom layer formed from an NMP-based slurry exhibited excellent electrode integrity. The inferior electrode integrity of the aqueous based bottom layer resulted in poor electrochemical performance. Thus, the bilayer hybrid graphite anode is preferably fabricated with a bottom layer formed from an NMP-based slurry.

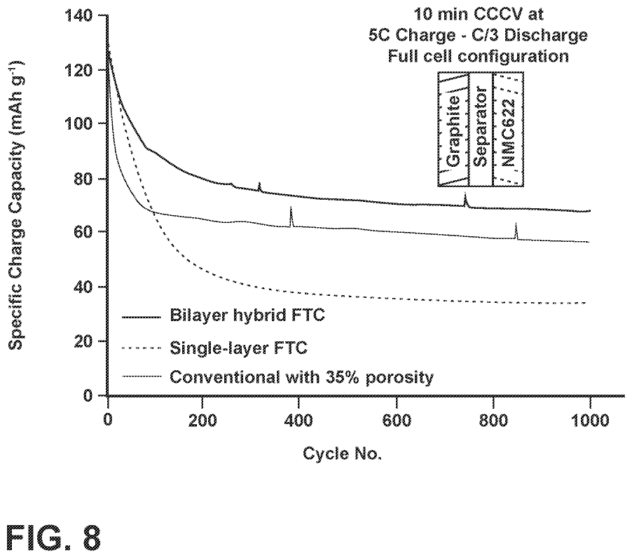

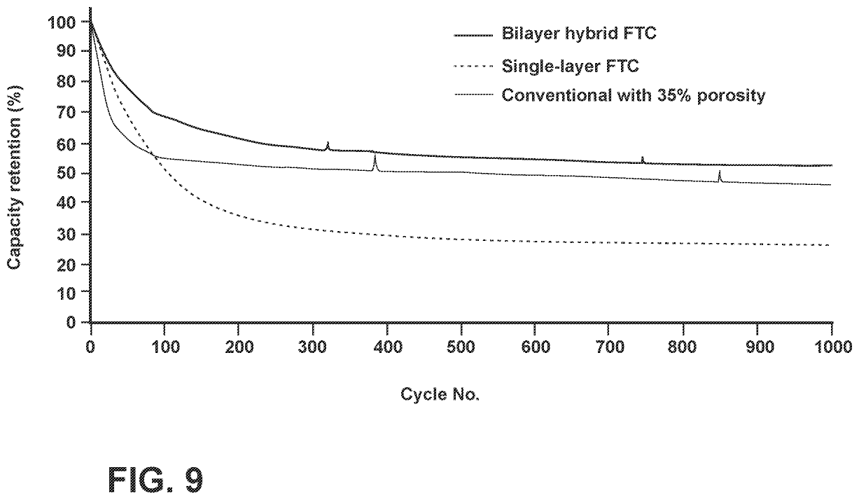

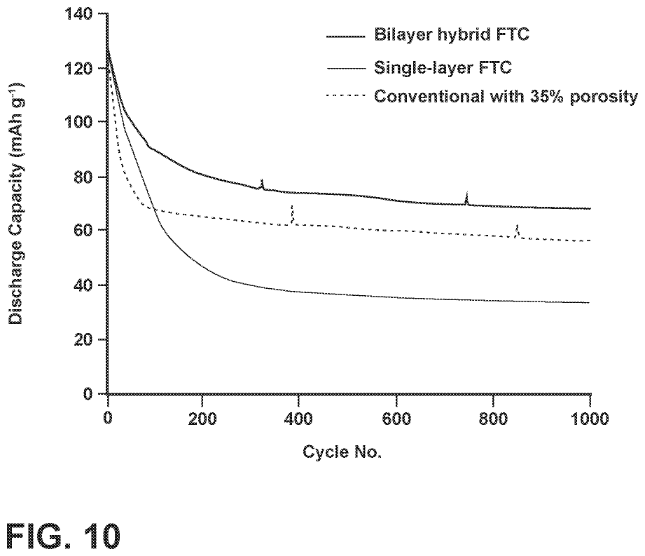

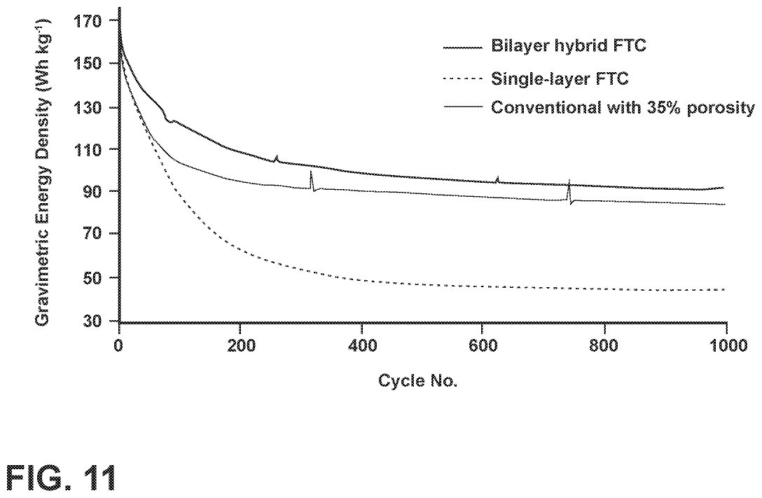

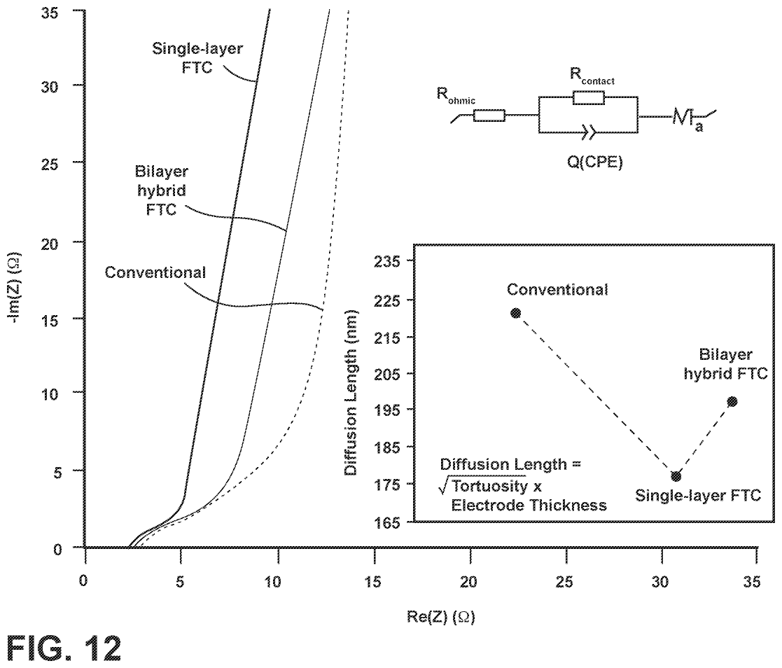

The XFC rate performance of the hybrid bilayer-coated anodes was systematically compared with the single-layer FTC anodes (Comparative Example 2) and conventionally coated graphite anodes (Comparative Example 1; 35% porosity) in a symmetric cell format. Electrodes were initially assembled into half-cells and lithiated to 50% SOC after undergoing a formation cycle. The half-cells were disassembled in a glove box, and symmetric cells were built with the 50% SOC electrodes. The symmetric cells were tested under XFC conditions, and the total charging time was limited to 10 min. The rate performance comparison of the single-layer conventionally coated electrode with 35% porosity (Comparative Example 1), the single-layer FTC electrode (Comparative Example 2), and the hybrid bilayer-coated electrode (Example 1) is shown graphically in FIG. 7. The rate performance of the single-layer conventionally coated electrode (Comparative Example 1) was similar to that shown in FIG. 3. Interestingly, the single-layer FTC electrode (Comparative Example 2) performed the worst in the symmetric cell format, displaying lower charge capacity than the single-layer conventionally coated electrode. This could be primarily attributed to the poor structural integrity and delamination issues with the single-layer FTC graphite electrode, which lead to poor performance at high current. In contrast, the hybrid bilayer-coated electrode (Example 1) not only exhibited excellent structural integrity, but also improved the attainable charge capacity by approximately 20% compared with the single-layer conventionally coated electrode (Comparative Example 1) at a 5 C rate. Higher charge capacity was also observed for the 5.5 C, 6.0 C, and 6.5 C rates. This improvement may be primarily attributed to the well-defined channels that reduce the electrode tortuosity and shorten the lithium-ion diffusion pathways, resulting in better rate performance at high currents. Long-term cycle testing on the three electrode architectures was also evaluated using the XFC protocol (with 10 min CCCV charging time at 5 C charge and C/3 discharge rate) in full cells, as shown graphically in FIG. 8. The capacity was normalized to NMC622. During the first cycle, the charge capacity at 5 C (˜130 mAh g⁻¹) was lower than the capacity at 1 C (˜170 mAh g⁻¹), mainly because of mass transport limitations at high current densities. All three configurations exhibited fast capacity fade at initial cycles (i.e., the first 100 cycles), and the cells with the single-layer conventionally coated anode (Comparative Example 1) appeared to have the worst performance. The capacity stabilized afterward, but the cells with a single-layer FTC graphite anode (Comparative Example 2) continued the significant degradation for another 100 cycles before slowing, demonstrating that these cells had the worst performance. The fast capacity degradation was likely caused by lithium plating, which is common with high areal loading under XFC. The full cells with the hybrid bilayer-coated graphite anode (Example 1) outperformed the two comparative examples throughout the 1,000 cycles, demonstrating an approximately 20% increase in specific capacity compared with the conventionally coated anode (Comparative Example 1). The capacity retention also follows a similar trend as the specific charge capacity, as shown graphically in FIG. 9. After 1,000 cycles, the capacity retention was 55% for the hybrid bilayer-coated electrode (Example 1), 45% for the single-layer conventionally coated electrode (Comparative Example 1), and 25% for the single-layer FTC electrode (Comparative Example 2). The specific discharge capacities showed a similar trend as the charge capacities, i.e. the hybrid bilayer-coated anode>the single-layer conventionally coated anode>single-layer FTC anode, as shown graphically in FIG. 10. The energy density of the full cells was calculated as shown in FIG. 11. The gravimetric energy density was calculated by dividing the energy of the cells by the mass of the anode, cathode, electrolyte, separator, and half the mass of current collector since single-sided electrodes were used in the coin cells. The energy density of the cells with the hybrid bilayer-coated graphite (Example 1) was approximately 12% higher than that of the single-layer conventionally coated graphite (Comparative Example 1). However, the capacity and energy density were still relatively low. This could be partially a result of the limitation of the conventional cathode since both anodes and cathodes need to have a desirable structure to maximize electrode performance. Nevertheless, the hybrid bilayer-coated graphite anode (Example 1) still demonstrated significant improvement over the single-layer conventionally coated graphite anode (Comparative Example 1), validating the benefits of the hybrid bilayer-coated architecture.

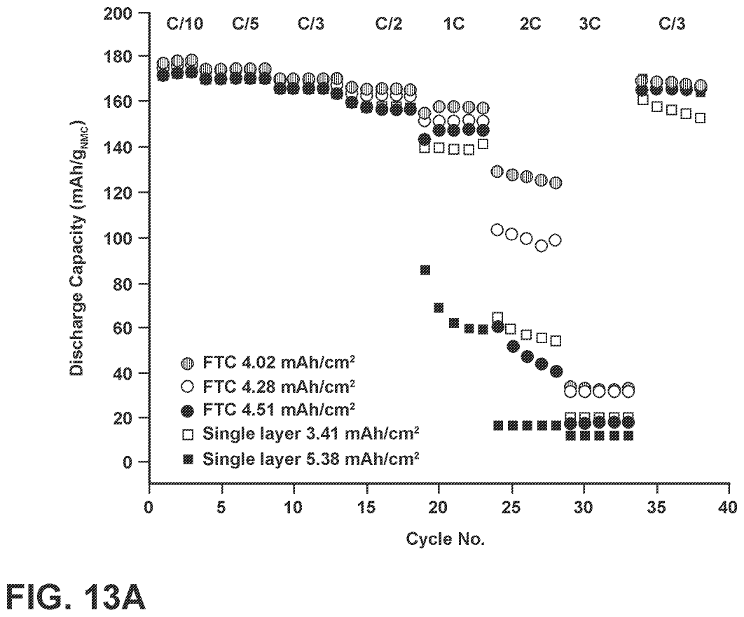

FIG. 12 graphically shows the Nyquist plot for the three different anode architectures carried out with symmetric cells with 0% SOC. Multiple measurements were taken for one condition, and to minimize the error, the connectors, cables and cyclers were kept same for all the experiments. The results in the Nyquist plot clearly demonstrate the lower impedance for the hybrid bilayer-coated anode (Example 1) compared with the single-layer conventionally coated and calendered anode (Comparative Example 1). The single-layer FTC anode (Comparative Example 2) showed the lowest resistance owing to its highly porous and less tortuous nature. The hybrid bilayer-coated anode (Example 1) showed slightly higher impedance than the single layer FTC anode (Comparative Example 2) owing to the presence of a thin, conventionally coated bottom layer. The conventionally coated electrode with 35% porosity (Comparative Example 1) exhibited the highest impedance, mainly because of the longer lithium-ion diffusion pathways, which resulted from the lower porosity and more random distribution of particles.

To verify the enhanced performance of the hybrid bilayer coated anodes, electrode tortuosity and diffusion lengths were calculated using Equations (1) and (2) above. To compute the tortuosity, the Nyquist impedance spectra in FIG. 12 were fitted using the ZFit tool in EC-Lab V11.22. The resulting ionic resistance (Rᵢₒₙ) was used to compute the electrode tortuosity, which was then used to determine the diffusion lengths (Eq. (2)) across the different electrode architectures (single-layer conventional coating, single-layer FTC coating, and hybrid bilayer coating). The electrode tortuosity followed the trend of single-layer FTC anode (tortuosity=2.1)<hybrid bilayer anode (tortuosity=2.9)<single-layer conventionally coated electrode with 35% porosity (tortuosity=6.1). The diffusion length calculations showed the trend of single-layer FTC anode<hybrid bilayer anode<single-layer conventionally coated anode. Compared with the conventionally coated graphite anode, the single-layer FTC graphite anode rendered a 21% reduction in diffusion length with similar areal loading. Although the single-layer FTC anode exhibited the shortest diffusion pathways, it did not show the best rate performance, mainly because of its poor structural integrity.

In sum, the single-layer FTC anode (Comparative Example 2) exhibited good structural integrity with thin coatings, but at the cost of low areal loading. The single-layer FTC anode also demonstrated some delamination after cycling. On the other hand, the hybrid bilayer-coated anode (Example 1) exhibited excellent rate performance under XFC conditions, with a ˜20% improvement in the specific charge capacity compared with the single-layer conventionally coated electrode (Comparative Example 1) at 5 C. This performance can be attributed to the shorter diffusion pathways that are created by the aligned channels developed via freeze casting. The hybrid bilayer-coated anode (Example 1) also exhibited significant improvement in long-term cycle life.

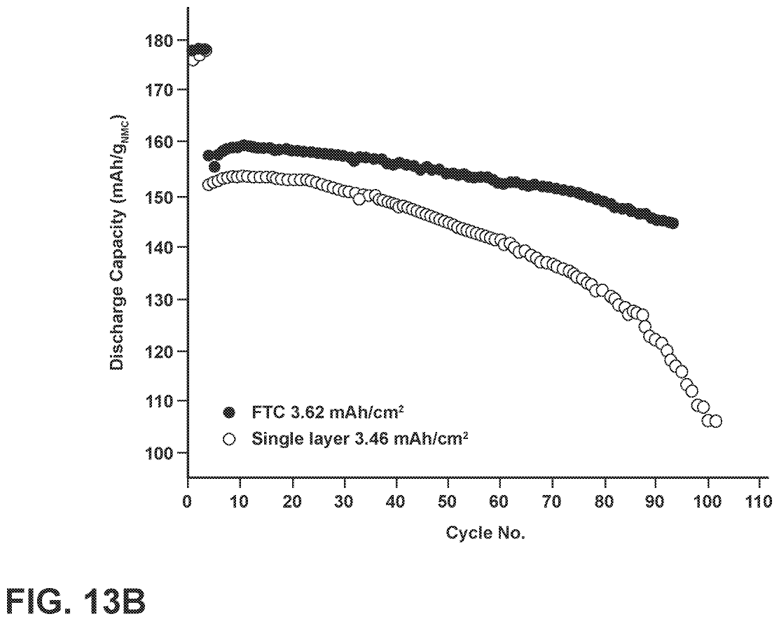

The method has also been shown to be effective for the fabrication of cathodes. The first layer was coated on the current collector and subjected to calendering to densify this first (bottom) layer. An aqueous-based slurry was used to form the second layer on top of the first layer by freeze tape casting. Three variables were taken into consideration: the solid to water content of the slurry, the freezing temperature or freezing temperature sequence (i.e., the size of water crystals and distance of walls between the water crystals), the wet gap thickness (i.e., active material loading), and the drying conditions of the second layer formed by freeze tape casting. Regarding temperature, a bed temperature (for freezing) of −20° C. and −9° C. were investigated. It was found that there was weak adhesion of the second layer at a temperature of −20° C., while a temperature of −9° C. resulted in a more robust interface between the second layer and the first layer. After casting of the second layer on the first layer, the coating was transferred on a cold substrate (at same or similar temperature to the freeze casting temperature) and vacuum dried in a vacuum chamber without the coating touching any surface of the vacuum chamber. The drying conditions for the second layer formed by freeze tape casting were adjusted to avoid melting of the coatings, collapse of the structures of the layers, and formation of defects. Regarding the slurry composition, it was found that reducing the water content from a solid to liquid (H₂O) ratio of 1:2 to a solid to liquid ratio of 1:1 provided a denser structure. The first layer of the cathode formed conventionally had a thickness in the range of 10 μm to 20 μm, while the second layer formed by freeze tape casting had a thickness in the range of 100 to 200 μm. As shown graphically in FIGS. 13A and 13B, the bilayer cathodes in accordance with the invention (labeled “FTC”) exhibited significant performance improvement over conventional single-layer cathodes (labeled “Single layer”).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing a hybrid bilayer-coated electrode, the method comprising:
providing a current collector;
forming a first layer on the current collector; and
forming a second layer on top of the first layer by freeze casting a slurry onto the first layer.

2. The method of claim 1, wherein the first layer is formed by coating a slurry-based composition on the current collector and subsequently calendering the slurry-based composition on the current collector.

3. The method of claim 2, wherein the slurry-based composition includes a solvent component including one or a combination of two or more solvents selected from a group of water, ethanol, propanol, toluene, N-methyl-2-pyrrolidone (NMP), dimethyl sulfoxide (DMSO) and triethyl phosphate (TEP).

4. The method of claim 1, wherein the slurry used to form the second layer includes one or more solvents, and the second layer is formed by: depositing a coating of the slurry on the first layer; freezing the solvent(s) after depositing the coating; and subsequently subliming the solvent(s) via controlling ambient temperature and/or pressure.

5. The method of claim 4, wherein the one or more solvents of the slurry for the second layer includes one or a combination of two or more solvents selected from a group of water, ethanol, propanol, toluene, N-methyl-2-pyrrolidone (NMP), dimethyl sulfoxide (DMSO) and triethyl phosphate (TEP).

6. The method of claim 1, wherein the slurry used to form the second layer is an aqueous slurry.

7. The method of claim 1, wherein the electrode is an anode or a cathode.

8. The method of claim 7, wherein the anode includes: an active material selected from a group of graphite, graphene, silicon, silicon oxide, germanium, lithium titanium oxide, niobium oxide, and titanium niobium oxide; a binder; and a conductive additive.

9. The method of claim 7, wherein the cathode includes: an active material selected from a group of lithium compounds including LiMPO₄ wherein M is Fe, Mg, or Mn, LiNiₓMn_{y}Co_{1-x-y}O₂, LiNi_{1.5}Mn_{0.5}O₄, and LiMO₂ wherein M is Ni, Mn, Co, Fe, Al, Ti, or Zn; a binder and a conductive additive.

10. The method of claim 1, wherein the first layer is densified to have a density equivalent to a range of 15% to 50% porosity.

11. The method of claim 1, wherein the second layer has a tortuosity that is less than a tortuosity of the first layer.

12. The method of claim 11, wherein the tortuosity of the second layer is approximately in the range of 1 to 3.

13. The method of claim 1, wherein the bilayer-coated electrode has an areal loading in the range of 1.5 to 5.5 mAh cm⁻².

14. The method of claim 1, wherein the step of forming the second layer is performed using a freeze tape caster.

15. A hybrid bilayer-coated electrode formed by the method of claim 1.

16. A hybrid bilayer-coated electrode comprising:
a current collector;
a first layer formed on a surface of the current collector; and
a second layer formed on top of the first layer such that the first layer is sandwiched between the current collector and the second layer;
wherein the second layer is formed by freeze casting;
wherein the first layer is formed by other than freeze casting;
wherein the second layer has a tortuosity that is less than a tortuosity of the first layer.

17. The hybrid bilayer-coated electrode of claim 16, wherein the first layer has a density equivalent to a range of 15% to 50% porosity.

18. The hybrid bilayer-coated electrode of claim 16, wherein the second layer has a tortuosity that is less than a tortuosity of the first layer.

19. The hybrid bilayer-coated electrode of claim 16, wherein the tortuosity of the second layer is approximately in the range of 1 to 3.

20. The hybrid bilayer-coated electrode of claim 16, wherein the bilayer-coated electrode has an areal loading in the range of 1.5 to 5.5 mAh cm⁻².
